(19) United States
(12) Patent Application Publication
(10) Pub. No.: US 2008/0119602 A1
(43) Pub. Date: May 22, 2008

(54) Polymers in a solid state

(75) Inventors: Ueli Sulser, Oberengstringen (CH); Irene Schober, Zurich (CH); Urs Mader, Frauenfeld (CH); Ulf Velten, Aarau (CH)

Correspondence Address: OLIFF & BERRIDGE, PLC, P.O. BOX 320850, ALEXANDRIA, VA, 22320-4850, US

(73) Assignee: SIKA SCHWEIZ AG, Zurich (CH)

(21) Appl. No.: 11/979,438

(22) Filed: Nov. 2, 2007

Related U.S. Application Data
(63) Continuation of application No. 10/506,773, filed on Aug. 11, 2005, now abandoned.

(30) Foreign Application Priority Data
Mar. 25, 2002 (EP) 02006760.9

(51) Int. Cl. C08K 11/00; C08F 8/32; C08F 8/46

(52) U.S. Cl. 524/502; 525/379; 525/384; 525/190

(57) ABSTRACT

The invention relates to polymers in a solid state which may be obtained by reaction of at least one polymer, produced from at least one monomer, selected from unsaturated mono- or di-carboxylic acids, or analogues of unsaturated mono- or di-carboxylic acids and optionally at least one ethylenically-unsaturated monomer with at least one polymer which is terminated at one end by terminal groups which are non-reactive under normal reaction conditions and hydroxy- or amino-functionalised at the other end thereof and, optionally, at least one amine. The invention further relates to polymers in a solid sate which may be obtained by the reaction of at least one monomer, selected from unsaturated mono- or di-carboxylic acids or analogues of unsaturated mono- or di-carboxylic acids in the presence of a radical initiating agent with at least one monomer, selected from the group of unsaturated esters or amides of a polymer, terminated at one end by terminal groups which are non-reactive under normal reaction conditions and hydroxy- or amino-functionalised at the other end thereof, with optionally at least one ethylenically unsaturated monomer. The production and use of solid polymers as dispersants and fluidising agents in cement systems is also disclosed.

This is a Continuation of application Ser. No. 10/506,773 filed Aug. 11, 2005, which is a PCT National Phase of Application No. PCT/EP03/02892 filed Mar. 19, 2003. The disclosures of the prior applications are hereby incorporated by reference herein in their entirety.

### TECHNICAL FIELD

The invention relates to the preparation of polymers in the solid state which can, when required, be dissolved in water and/or dispersed in water without leaving a residue, and also processes for preparing them and their use.

### PRIOR ART

Polyalkylene glycol carboxylates have for some years been used as dispersants for aqueous dispersions. They make it possible to achieve a drastic reduction in the water content of these dispersions. These polymers are prepared in aqueous solution or are obtained as aqueous polymer solutions. The disadvantage of these solutions are the high transport costs, since a large proportion of solvent has to be transported together with the polymer. Furthermore, bacterial attack can occur, especially in aqueous solutions. Aqueous solutions are sensitive to freezing, i.e. they can firstly, freeze and, secondly, crystallization of solids can occur under cool storage conditions. This requires special storage conditions. When polyalkylene glycol carboxylates have ester groups resulting, for example, from copolymerization of acrylic esters, their aqueous solutions have only a limited shelf life, since these esters tend to hydrolyze, especially at relatively high temperatures.

Powders or solids have the technical advantage over aqueous solutions that transport involves significantly lower costs, the shelf life is significantly longer due to reduced biological attack or reduced cleavage of possible ester bonds in the modified polycarboxylates and the sensitivity to freezing is significantly reduced.

WO 0017263 describes the preparation of water-soluble polymer powders based on polyoxyalkylene glycol carboxylates by drying aqueous polymer solutions with addition of stabilizers.

EP 1052232 describes the preparation of a pulverulent dispersant, in which a reducing agent is added to the liquid containing a polycarboxylate polymer and the liquid containing a reducing agent is subsequently dried and powdered.

WO 0047533 describes the preparation of pulverulent polymer compositions with incorporation of a mineral support material into a polyether carboxylate.

Solid polymers which are prepared from solutions by drying require an additional process step, consume a great deal of energy and are expensive. Polymer powders which are mixed with a mineral support material are not suitable for the preparation of stable aqueous polymer solutions after redissolution.

### SUMMARY OF THE INVENTION

It is therefore an object of the present invention to overcome the above-described disadvantages of the prior art and to prepare a polymer which is obtained in the solid state and can, if necessary, be redissolved in water and/or redispersed in water without leaving a residue, without a spray-drying step or water-insoluble additives being required. It has unexpectedly been found that the disadvantages of the prior art can be overcome according to the invention by means of polymers in the solid state as defined in claim 1 or 2.

The present invention describes polymers in the solid state which are obtainable by reaction of at least one polymer A which is prepared from at least one unsaturated monocarboxylic or dicarboxylic acid or an analog thereof (a) and, optionally, at least one ethylenically unsaturated monomer (b) with at least one polymer B which is terminated at one end by end groups which are not reactive under customary reaction conditions and is hydroxyl- or amine-functionalized at the other end and, optionally, with at least one amine C.

Furthermore, such polymers in the solid state are also obtainable by reaction of at least one unsaturated monocarboxylic or dicarboxylic acid or an analog thereof (a) in the presence of a free-radical former with at least one unsaturated ester or amide (c) of a polymer B which is terminated at one end by end groups which are not reactive under customary reactive conditions and is hydroxyl- or amine-functionalized at the other end and, optionally, with at least one ethylenically unsaturated monomer (b). The preparation and the use of the solid polymer as dispersant and fluidizer in cement-containing systems are also described.

### DESCRIPTION OF THE INVENTION

The present invention provides polymers in the solid state which are obtainable by reaction of at least one polymer A which has been prepared from at least one monomer a selected from among unsaturated monocarboxylic and dicarboxylic acids and analogs of unsaturated monocarboxylic and dicarboxylic acids and, optionally, at least one ethylenically unsaturated monomer b with at least one polymer B which is terminated at one end by end groups which are not reactive under customary reaction conditions and is hydroxy- or amine-functionalized at the other end and, optionally, with at least one amine C.

For the purposes of the invention, “solid polymers” or “polymers in the solid state” are polymers which are in the solid state at room temperature and are, for example, powders, flakes, pellets or sheets and can be transported and stored without problems in this form.

For the purposes of the invention, “terminated by end groups which are not reactive under customary reaction conditions” means that the groups present are not functional groups which are reactive in esterification or amidation but instead are groups which are no longer capable of reacting. The customary reaction conditions are those which a person skilled in the art will know for esterifications and amidations. In the case of compounds “terminated at one end”, only one end is no longer capable of reaction.

Polymer A can be obtained by polymerization of at least one monomer a and, optionally, at least one monomer b.

Monomer a is selected from the group consisting of unsaturated monocarboxylic acids, unsaturated dicarboxylic acids, analogs thereof and mixtures thereof. Unsaturated monocarboxylic or dicarboxylic acids are preferably maleic acid, itaconic acid or crotonic acid, in particular acrylic acid or methacrylic acid. For the purposes of the present invention, analogs of monocarboxylic or dicarboxylic acids are acid salts, acid halides, acid anhydrides and esters, in particular alkyl esters.

Monomer b is selected from the group consisting of ethylenically unsaturated monomers. Such ethylenically unsaturated monomers include, in particular,

ethylenically unsaturated aromatics such as styrene, alpha-methylstyrene,
vinyl compounds such as N-vinylpyrrolidone, vinyl acetate, vinyl ethyl ether, vinylsulfonic acid, vinylcaprolactam,
(meth)allyl compounds such as (meth)allylsulfonic acid, allyl glycidyl ether, allyl polyglycol ethers,
unsaturated amides or nitrites such as acrylonitrile or acrylamide,
ethylenically unsaturated compounds such as ethylene, propylene, butylene, isobutylene.

The polymer A can also be in the form of a salt or be in partially neutralized form.

In the preparation of the polymer A, any initiators, coinitiators and polymerization regulators used have to be chosen so that no reactive hydroxyl or amine functions are present in the polymer A.

The molar ratio of the monomer building blocks a and b in the polymer A is usually in the range 100:0-20:80, preferably 100:0-30:70, in particular 98:2-70:30.

For the purposes of the invention, the “molecular weight” is the weight average molecular weight M_{w}.

The molecular weight of the polymer A is, for example, 1000-100 000 g/mol, preferably 1000-50 000 g/mol, particularly preferably 2000-30 000 g/mol, in particular 2000-15 000 g/mol.

Polymer B is terminated at one end by end groups which are not reactive under customary reactive conditions. It is preferably a polymer having a polyalkylene glycol skeleton. This polymer B preferably corresponds to the formula

X-(EO)ₓ—(PO)_{y}-(BuO)_{z}—R
where x, y, z are each, independently of one another, in the range 0-250 and x+y+z=3 or above;
X=OH or NHR′, where R′=alkyl having 1-20 carbon atoms, alkylaryl having 7-20 carbon atoms or H, preferably R′=H;
EO=ethylenoxy, PO=propylenoxy, BuO=butylenoxy or isobutylenoxy;
and R=alkyl having 1-20 carbon atoms or alkylaryl having 7-20 carbon atoms.

The ethylene oxide (EO), propylene oxide (PO) and butylene oxide (BuO) units in polymer B can be arranged in blocks and/or randomly.

The molar ratio of polymers B containing hydroxyl end groups to polymers B containing amine end groups is from 100:0 to 0:100, preferably from 100:0 to 5:95, in particular from 100:0 to 20:80, particularly preferably 100:0 to 91:9.

In the preparation of the solid polymer, the amines C are selected from among ammonia, ammonia salts, primary, secondary linear and branched C1-C20-alkylamines and secondary C1-C20-hydroxyamines.

The ratio of the sum of the carboxylic acid groups or their analogs in polymer A to the sum of the hydroxyl and amino groups in the polymers B is from 50:1 to 1.1:1, preferably from 30:1 to 1.1:1.

For the preparation of the solid polymer, 0-0.5 units, preferably 0.01-0.3 units, of amine C are used per carboxylic acid group or analog thereof in polymer A.

The reaction of polymers A with polymers B and, optionally, amines C is carried out under conditions which lead to at least partial esterification or amidation of the carboxylate groups in polymer A. The reaction is preferably carried out at elevated temperature, particularly preferably from 140 to 250° C., in particular from 150 to 200° C. Esterification catalysts such as Lewis acids can be added. By-products formed can be removed from the polymer melt during the reaction, for example by means of a stream of air or nitrogen, vacuum or salt precipitation.

The invention also describes polymers in the solid state which are obtainable by reaction of at least one monomer a selected from among unsaturated monocarboxylic and dicarboxylic acids and analogs of unsaturated monocarboxylic and dicarboxylic acids in the presence of a free-radical former with at least one monomer c selected from the group consisting of unsaturated esters and amides of polymers B which is terminated at one end by end groups which are not reactive under customary reaction conditions and is hydroxy- or amine-functionalized at the other end with, optionally, at least one ethylenically unsaturated monomer b.

The monomers a, b and polymer B have been described above. Monomers c are selected from the group consisting of unsaturated esters and amides of polymers B. A monomer c is preferably an ester or amide of an α,β-unsaturated carboxylic acid, in particular an ester or amide of acrylic acid or methacrylic acid.

The molar ratios of the monomers a, b and c in the above copolymer conform to the condition (a+c):b=100:0 to 30:70, preferably from 100:0 to 50:50, in particular from 98:2 to 70:30. The molar ratio of the monomers a and c in the copolymer conforms to the condition a:c=200:1 to 0.1:1, preferably from 100:1 to 0.1:1, in particular from 29:1 to 0.1:1.

The copolymerization of the monomers a, b and c can be carried out by the conventional free-radical copolymerization technique. Suitable initiators are, for example, organic or inorganic peroxides, hydrogen peroxides, persulfates or organic azo compounds. To regulate the molecular weights, it is possible to add regulators such as inorganic or organic sulfur compounds, aldehydes, formic acid or inorganic phosphorus compounds. The polymerization can also be initiated by means of redox initiators. The reaction can be carried out in the absence of solvents or in a solvent. Examples of suitable solvents are toluene, benzene, water and mixtures thereof, preferably water. When a solvent is used, the polymer has to be separated off from the solvent before processing, which can be done by precipitating the polymer and subsequently separating off the solvent or by distilling off the solvent under reduced pressure or under atmospheric pressure. The polymer may have to be melted by supplying heat. The resulting polymer melt can be processed further as described.

In both possible ways of preparing the solid polymers, the following are preferred.

It is advantageous for the proportion by weight of the sum of propylene oxide (PO) and butylene oxide (BO) units to be not more than 29% by weight of the polymer B, in particular to be less than 20% by weight.

It is advantageous for the molecular weight of the polymer B to be about 120-20 000 g/mol, in particular about 250-10 000 g/mol.

Furthermore, it is advantageous for the proportion of all polymers B having molecular weights below 500 g/mol to be not more than 70 mol % of all polymers B, preferably to be less than 50 mol %, in particular less than 30 mol %.

A person skilled in the art will know that industrially prepared monofunctional polyalkylene oxides, i.e. polyalkylene diols which are terminated at one end by end groups which are not reactive under customary reaction conditions, always contain a proportion of impurities which are not terminated by end groups. In particular, these are compounds which are termed “bifunctional” by those skilled in the art. The proportion by weight of bifunctional polymers in the polymer B is advantageously less than 3% by weight, preferably less than 2% by weight, in particular less than 1% by weight, based on the weight of polymer B.

It has been found that the addition of particular water-soluble or water-dispersible materials can accelerate the solidification reaction of the polymer melt. Examples of such materials are organic or inorganic salts such as alkali metal or alkaline earth metal salts of nitric acid, phosphoric acid, phosphorous acid, fatty acids, sulfonic acids, phthalic acid and organic compounds such as urea, higher alcohols such as fatty alcohols or neopentyl glycol. These additives can be added to the polymer melt at any point in time prior to processing.

These additives are added to the polymer, preferably the melt, in an amount of from 0 to 5% by weight, based on the polymer in the solid state.

For the present purposes, the expression “prior to processing of the polymer melt” refers to any processing step during the preparation of the polymer which is carried out prior to solidification of the polymer melt.

The polymer melt present in the reactor at the end of the reaction can be dispensed into containers and allowed to solidify there. These solid polymers can be melted again for further processing and then be processed further.

The polymer melt present in the reactor at the end of the reaction can, however, also be processed further continuously or batchwise by means known to those skilled in the art which are suitable for the production of handleable solids. For example, they can be cast to form sheets and, after solidification in this form, be comminuted, for example by chopping, milling or pelletizing. The solidification process can, for example, be accelerated by cooling. As another example of further processing of the polymer melt, the polymer melt can also be pelletized directly, for example by means of a cooling bath and a chopper.

In a preferred embodiment of the invention, the solid polymers can be used as dispersants for inorganic or organic dispersions. Examples of such dispersions are calcium carbonate dispersions, dye dispersions, gypsum plaster slurries, dispersions of hydraulic binders or coal slurries.

In a more preferred embodiment, the solid polymers can be used as dispersants for dispersions comprising hydraulically setting binders or mixtures of hydraulically setting binders with latently hydraulic binders. Such dispersants are referred to in concrete technology as fluidizers. Hydraulically setting binders are, for example, cement, slags, plaster of Paris or anhydrite. Latently hydraulically setting binders are, for example, pozzolanas or fly ash. One specific use is the use as fluidizers in ready-to-use mortars.

The novel polymers in the solid state can be used directly by mixing them, for example as powder or pellets, into the materials to be dispersed or, if the materials to be dispersed have to be milled, the solid polymers can, if appropriate, be added to the materials to be dispersed prior to the milling process. The solid polymers can, however, also be used as aqueous solutions after dissolution in water.

Other additives can also be added to the solid polymer, preferably before processing of the polymer melt. Such additives can be, for example, alkalis such as alkali metal or alkaline earth metal hydroxides, ammonium, C1-C2-alkylamines, other dispersants such as sulfonated naphthalene condensates, sulfonated melamine condensates, lignosulfonates, polyacrylates, other polycarboxylates or setting retarders and/or setting accelerators for hydraulically setting binders, viscosity modifiers, surface-active substances such as surfactants or antifoams or shrinkage reducers.

### EXAMPLES

### Preparation by Reaction of Polymer A with Polymer B

### Examples PA-1 to PA-5

### Method of Preparation for Polymer PA-1 According to the Invention

160 g of a 50 percent strength aqueous solution of polyacrylic acid (molecular weight: 4500) and 5.0 g of a 50 percent strength sulfuric acid are placed in a round-bottomed flask provided with mechanical stirrer, thermometer, gas inlet tube and distillation attachment. The mixture is heated to 50° C. and 400 g of polyethylene glycol monomethyl ether (molecular weight: 2000) are added. The mixture is heated to 160° C. under a stream of N₂. The water present in the mixture and the water of reaction are distilled off continuously under a stream of N₂. After four hours, an acid number of 1.5 mmol of H+/g has been reached and the polymer melt is poured into aluminum dishes having a diameter of about 100 mm and a height of about 7 mm and standing on unheated ceramic plates of a laboratory table and allowed to solidify.

Polymers PA-2 to PA-5 were prepared in a similar way to polymer PA-1 using the starting materials and reaction times indicated in Table a.

### Method of Preparation for Comparative Polymers CA-1 and CA-2

The comparative polymers CA-1 and CA-2 were prepared in the same way as polymer PA-1 using the starting materials and reaction times indicated in Table b.

TABLE a
Preparation of the polymers PA-2 to PA-5 according to the invention

| | | Amount | | Amount | Sulfuric | Reaction time | |
|---|---|---|---|---|---|---|---|
| | Polycarboxylic acid solution | used | Polyalkylene glycol | used | acid, 50% | at 160° C. | Acid number |
| Polymer | in H₂O (polymer A) | (g) | (polymer B) | (g) | strength (g) | (hours) | (mmol H⁺/g) |
| PA-2 | Polyacrylic acid having M_{w} = | 160 | Methoxypolyethylene | 600 | 6.0 | 5 | 1.00 |
| | 4500 g/mol, 50% in H₂O | | glycol having M_{w} = | | | | |
| | | | 3000 g/mol | | | | |
| PA-3 | Copolymer of methacrylic acid | 230 | Methoxypolyethylene | 440 | 3.0 | 3 | 1.05 |
| | and acrylic acid in a molar | | glycol having M_{w} = | | | | |
| | ratio of 3:1 having M_{w} = | | 2000 g/mol | | | | |
| | 4500 g/mol, 40% strength in H₂O | | | | | | |
| PA-4 | Polymethacrylic acid having M_{w} = | 245 | Methoxypolyethylene | 400 | 2.0 | 3.5 | 0.80 |
| | 4100 g/mol, 40% in water | | glycol having M_{w} = | | | | |
| | | | 2000 g/mol | | | | |
| PA-5 | Copolymer of methacrylic acid | 230 | Methoxypolyethylene | 300 | 2.0 | 2.5 | 1.10 |
| | and acrylic acid in a molar | | glycol having M_{w} = | and | | | |
| | ratio of 3:1 having M_{w} = 4500 | | 2000 g/mol and | 60 | | | |
| | g/mol, 40% in H₂O | | methylpolyethylene | | | | |
| | | | glycolamine having M_{w} = | | | | |
| | | | 520 g/mol | | | | |

TABLE b
Preparation of the comparative polymers CA-1 and CA-2

| | | Amount | | Amount | Sulfuric | Reaction time | |
|---|---|---|---|---|---|---|---|
| | Polycarboxylic acid solution | used | Polyalkylene glycol | used | acid, 50% | at 160° C. | Acid number |
| Polymer | in H₂O (polymer A) | (g) | (polymer B) | (g) | strength (g) | (hours) | (mmol H⁺/g) |
| CA-1 | Copolymer of methacrylic acid | 230 | Methoxypolyethylene | 175 | 1.5 | 1.5 | 1.50 |
| | and acrylic acid in a molar | | glycol having M_{w} = | | | | |
| | ratio of 3:1 having M_{w} = | | 350 g/mol | | | | |
| | 4500 g/mol, 40% strength in H₂O | | | | | | |
| CA-2 | Polyacrylic acid having M_{w} = | 155 | Methoxypolyethylene | 400 | 1.0 | 2.5 | 1.60 |
| | 7000 g/mol, 54% strength in H₂O | | oxide-polypropylene | | | | |
| | | | oxide-amine having an | | | | |
| | | | EO/PO ratio of 70/30 and | | | | |
| | | | having M_{w} = 2000 g/mol | | | | |

The polymers PA1-PA5 could be detached as plates from the dishes without problems after cooling and solidification and broken up into small pieces which were not sticky.

The comparative polymers CA-1 and CA-2 remained viscous and sticky after 24 hours at room temperature and also after 24 hours at 6° C.

### Method of Preparation for the Reaction of Monomer a with Monomer c and, if Applicable, Monomer b

### Method of Preparation for Polymer According to the Invention (Example PC-1)

70 g of deionized water are placed in a 500 ml round-bottomed flask provided with mechanical stirrer, thermometer and reflux condenser and heated to 75-80° C. As soon as the temperature has been reached, the monomer mixture (consisting of 121.2 g of an ester of methacrylic acid with polyethylene glycol 5000 monomethyl ether, 12.1 g of methacrylic acid and 140 g of water) and a solution of 3.1 g of sodium peroxodisulfate in 40 g of water are metered in simultaneously via different metering pumps over a period of 4 hours. Immediately at the beginning and every 15 minutes, thiolactic acid is added in 8 portions amounting to a total of 1.4 g. 0.8 g of sodium peroxodisulfate in 5.0 g of water is subsequently added and polymerization is continued at 75-80° C. until the peroxide test is negative. A pH of 4.7 is set by addition of 6.4 g of NaOH (50% strength). The reflux condenser is then replaced by a distillation attachment and the water is distilled off. The viscous polymer melt is poured into aluminum dishes having a diameter of about 100 mm and a height of about 7 mm and standing on unheated ceramic plates of a laboratory table and allowed to solidify.

### Method of Preparation for Comparative Polymer (Example CC-1)

92.0 g of deionized water are placed in a 500 ml round-bottomed flask provided with mechanical stirrer, thermometer and reflux condenser and heated to 85-90° C. As soon as the temperature has been reached, the monomer mixture (consisting of 103.0 g of an ester of methacrylic acid with polyethylene glycol 500 monomethyl ether, 44.7 g of methacrylic acid and 110 g of water), a solution of 4.6 g of sodium pyrosulfite in 39.0 g of water and a solution of 5.7 g of sodium peroxodisulfate in 40.0 g of water are metered in simultaneously via different metering pumps over a period of 2 hours. The mixture is subsequently allowed to continue to react at 85-90° C. until the peroxide test is negative. The reflux condenser is then replaced by a distillation attachment and the water is distilled off. The polymer melt is poured into aluminum dishes having a diameter of about 100 mm and a height of about 7 mm and standing on unheated ceramic plates of a laboratory table and allowed to solidify.

The polymer PC-1 could be detached from the dishes as a plate without problems after cooling and solidification and broken up into small pieces which were not sticky. The comparative polymer CC-1 did not become solid even after 24 hours, but remained soft.

### Example of the Use of Calcium Hydroxide as Accelerator for the Solidification Reaction of the Polymer Melt

The preparation of polymer PA-1 is repeated using the same batch size. The polymer melt is cooled to 100° C. and 2 percent by weight of calcium hydroxide powder are added and mixed in well for 5 minutes. The polymer melt is subsequently poured onto a metal sheet and allowed to solidify. The hardness of the solid polymers was tested with the aid of a Shore A hardness testing instrument, DIN 53505. Solidification with addition of calcium hydroxide powder occurs significantly more quickly than without, as shown in Table c.

TABLE c
Solidification rate of the polymer melts PA-1 with and without addition
of calcium hydroxide (laboratory temperature = 23° C.).

| | Shore A hardness after: | | | | | | |
|---|---|---|---|---|---|---|---|
| | 5 | 10 | 15 | 30 | 60 | 90 | 120 |
| | min. | min. | min. | min. | min. | min. | min. |
| without | soft, | soft, | soft, | soft, | 55 | 59 | 60 |
| Ca(OH)2 | n.m.^{I} | n.m.^{I} | n.m.^{I} | n.m.^{I} | | | |
| with | soft, | surface | 56 | 59 | 62 | 62 | 64 |
| Ca(OH)2 | n.m.^{I} | hard | | | | | |
| | | but | | | | | |
| | | still | | | | | |
| | | n.m.^{I} | | | | | |

^{I}n.m. = “not measurable”

As can be seen from Table c, the addition of calcium hydroxide results in the polymer reaching a solidity after 15 minutes equal to that which is achieved only after 60 minutes without the addition.

### Example of the Preparation of Aqueous Polymer Solutions from the Solid Polymers

30 g of solid polymer PA-1 are dissolved in 70 g of water. A clear, yellowish polymer solution is obtained.

30 g of solid polymer PA-1 which had been allowed to solidify with addition of 2 percent by weight of calcium hydroxide powder are dissolved in 70 g of water. A turbid, yellowish polymer solution is obtained.

1. A polymer in the solid state obtainable by reaction of at least one polymer A prepared from
at least one monomer a selected from among unsaturated monocarboxylic and dicarboxylic acids and analogs of unsaturated monocarboxylic and dicarboxylic acids,
and
optionally, at least one ethylenically unsaturated monomer b,
with at least one polymer B which is terminated at one end by end groups which are not reactive under customary reaction conditions and is hydroxy- or amine-functionalized at the other end,
and, optionally, at least one amine C.

2. A polymer in the solid state obtainable by reaction of at least one monomer a selected from among unsaturated monocarboxylic and dicarboxylic acids and analogs of unsaturated monocarboxylic and dicarboxylic acids,
in the presence of a free-radical former
with at least one monomer c selected from the group consisting of unsaturated esters and amides of a polymer B which is terminated at one end by end groups which are not reactive under customary reaction conditions and is hydroxy- or amine-functionalized at the other end,
and, optionally, at least one ethylenically unsaturated monomer b.

3. The polymer in the solid state as claimed in claim 1, characterized in that the analog of the unsaturated monocarboxylic or dicarboxylic acid is selected from the group consisting of acid salts, acid halides, acid anhydrides and esters.

4. The polymer in the solid state as claimed in claim 1, characterized in that the polymer B which is terminated at one end by end groups which are not reactive under customary reaction conditions and is hydroxy- or amine-functionalized at the other end has the following formula:
X-(EO)ₓ—(PO)_{y}-(BuO)_{z}—R
where x, y, z are each, independently of one another, in the range 0-250 and x+y+z=3 or above;
X=OH or NHR′, where R′=alkyl having 1-20 carbon atoms, alkylaryl having 7-20 carbon atoms or H, preferably R′=H;
EO=ethylenoxy, PO=propylenoxy, BuO=butylenoxy or isobutylenoxy;
and R=alkyl having 1-20 carbon atoms or alkylaryl having 7-20 carbon atoms.

5. The polymer in the solid state as claimed in claim 1, characterized in that the polymer B contains bifunctional polymer impurities in a proportion by weight of less than 3% by weight, preferably less than 2% by weight, in particular less than 1% by weight, based on the weight of the polymer B.

6. The polymer in the solid state as claimed in claim 4, characterized in that the proportion by weight of the sum of propylene oxide (PO) and butylene oxide (BO) units does not exceed 29% by weight of the polymer B, in particular is less than 20%.

7. The polymer in the solid state as claimed in claim 1, characterized in that monomer a is maleic acid, itaconic acid or crotonic acid, preferably acrylic acid or methacrylic acid.

8. The polymer in the solid state as claimed in claim 1, characterized in that the molecular weight of the polymer B is about 120-20 000 g/mol, in particular about 250-10 000 g/mol.

9. The polymer in the solid state as claimed in claim 1, characterized in that the polymer A has a molecular weight in the range 1000-100 000 g/mol, preferably 1000-50 000 g/mol, particularly preferably 2000-30 000 g/mol, in particular 2000-15 000 g/mol.

10. The polymer in the solid state as claimed in claim 1, characterized in that the molar ratio of the monomer building blocks a and b in the polymer A is in the range 100:0-20:80, preferably 100:0-30:70, in particular 98:2-70:30.

11. The polymer in the solid state as claimed in claim 1, characterized in that the polymer in the solid state is in the form of powder, flakes or in sheets.

12. The polymer in the solid state as claimed in claim 1, characterized in that at least one concrete fluidizer is added to the polymer prior to solidification.

13. The polymer in the solid state as claimed in claim 1, characterized in that at least one additive for hydraulically or latently hydraulically setting binders from the group consisting of setting retarders, setting accelerators, viscosity modifiers and shrinkage reducers is added to the polymer prior to solidification.

14. A process for preparing a polymer in the solid state as claimed in claim 1, characterized in that the polymer in the solid state is obtained by cooling a polymer melt and is, optionally, comminuted to give a transportable form.

15. A process for preparing a polymer in the solid state as claimed in claim 2 by copolymerization of at least one ethylenically unsaturated monomer containing carboxyl groups or analogs thereof with at least one ester or amide of ethylenically unsaturated monocarboxylic or dicarboxylic acids with a polymer B and, optionally, further, copolymerizable monomers and, optionally, in a solvent which is subsequently removed.

16. The process for preparing a polymer in the solid state as claimed in claim 14, characterized in that water-soluble or water-dispersible accelerators for the curing reaction of the polymer melt are added to the polymer melt prior to cooling.

17. The process for preparing a polymer in the solid state as claimed in claim 16, characterized in that accelerators selected from the group consisting of inorganic and organic salts, urea and higher alcohols are used as water-soluble or water-dispersible accelerators for the solidification reaction of the polymer melt.

18. The use of the polymer in the solid state as claimed in claim 1 as dispersant for aqueous dispersions.

19. The use of the polymer in the solid state as claimed claim 1 as fluidizer for hydraulically setting systems.

20. The use of the polymer in the solid state as claimed in claim 1 as fluidizer in ready-to-use mortar systems.

21. The use of the polymer in the solid state as claimed in claim 1 dissolved in water as fluidizer for cement-containing systems.

22. An aqueous solution obtained by dissolving the polymer in the solid state as claimed in claim 1 in water.
